(19) United States
(12) Patent Application Publication
(10) Pub. No.: US 2009/0073138 A1
(43) Pub. Date: Mar. 19, 2009

(54) Display panel and display apparatus having the same

(75) Inventors: Myung-Woo Lee, Seoul (KR); Hyung-Guel Kim, Yongin-si (KR); Kee-Han Uh, Yongin-si (KR); Soo-Guy Rho, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/221,329

(22) Filed: Aug. 1, 2008

(30) Foreign Application Priority Data
Sep. 13, 2007 (KR) 10-2007-0093169

(51) Int. Cl. G06F 3/041

(52) U.S. Cl. 345/173

(57) ABSTRACT

A display panel having a touch screen, the display panel includes an array substrate having a plurality of pixels and an opposite substrate having a plurality of touch electrodes. The array substrate includes the pixels receiving a data signal through thin film transistors and sensors electrically and physically making contact with the touch electrodes in response to an external pressure. Each sensor generates a common voltage input through the touch electrode in response to a scan signal controlling the thin film transistor as a sensing signal. Based on the generated sensing signal, a location coordinate to which the external pressure is applied is calculated, so that the number of wires for the display panel may decrease.

### CROSS-REFERENCE TO RELATED APPLICATION

This application relies for priority upon Korean Patent Application No. 10-2007-93169 filed in the Korean Intellectual Property Office on Sep. 13, 2007, the contents of which are herein incorporated by reference in its entirety.

### BACKGROUND OF THE INVENTION

1. Field of the Invention

The present invention relates to a display panel and a display apparatus having the display panel. More particularly, the present invention relates to a display panel having a touch screen function and a display apparatus having the display panel.

2. Description of the Related Art

In general, a touch screen panel is arranged on a display panel and generates a data corresponding to a touch position. Besides signal lines for transmission of signals used to display an image, the touch screen panel further includes additional signal lines for calculation of a touch coordinate. Therefore, a size of the touch screen panel becomes larger and a manufacturing cost of the touch screen panel increases.

Also, a conventional touch screen panel is operated in accordance with a single touch method that calculates one touch coordinate with respect to one touch position. However, digital devices these days include various additional functions, and thus various data input methods are required in order to meet various needs of users. That is, there have been demands for development of a touch screen panel operated in a multiple touch method capable of calculating multiple touch coordinates with respect to multiple touch positions.

### SUMMARY OF THE INVENTION

The present invention provides a display panel capable of reducing a number of signal lines and calculating multiple touch coordinates.

The present invention also provides a display apparatus having the display panel.

In one aspect of the present invention, a display panel includes an array substrate in which pixels are arranged. The array substrate includes first signal lines, second signal lines intersecting with the first signal lines and electrically connected to the pixels, and sensors. The sensors sequentially receive a scan signal through the second signal lines and generate a sensing signal corresponding to an external pressure to output the sensing signal through the first signal lines in response to a scan signal.

In another aspect of the present invention, a display apparatus includes a scan driver, a data driver, and a display panel. The scan driver sequentially outputs a scan signal, and the data driver outputs a data signal. The display panel includes pixels that display an image in response to the scan signal and the data signal. The display panel includes first signal lines, second signal lines, and sensors. The second signal lines are intersected with the first signal lines and electrically connected to the pixels. The sensors sequentially receive the scan signal through the second signal lines and generate a sensing signal corresponding to an external pressure to output the sensing signal through the first signal lines in response to the scan signal.

According to the above, the y-axis coordinate is calculated using the scan signal applied to the pixel. Thus, the display panel does not require a separate signal line that is used to calculate the y-axis coordinate, so that the number of signal lines may decrease. Also, since the y-axis coordinate is calculated according to the scan signals, multiple touch coordinates corresponding to multiple touches may be more precisely calculated.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a first exemplary embodiment of a display panel according to the present invention;

FIG. 2 is a plan view showing an array substrate of FIG. 1;

FIG. 3 is a sectional view taken along a line I-I′ of FIG. 2;

FIG. 4 is a plan view showing a second exemplary embodiment of an array substrate according to the present invention;

FIG. 5 is a block diagram showing an exemplary embodiment of a display apparatus according to the present invention;

FIG. 6 is a block diagram showing a signal analyzer of FIG. 5;

FIG. 7 is a circuit diagram showing an amplifier of FIG. 6;

FIG. 8 is a circuit diagram showing a display panel of FIG. 5; and

FIG. 9 is a waveform diagram of input and output signals applied to the display panel of FIG. 8.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

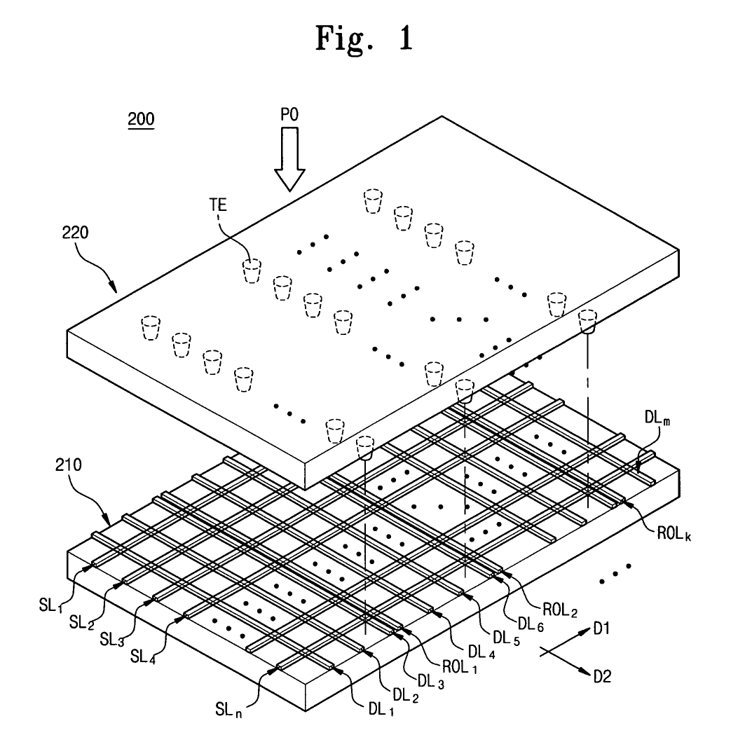

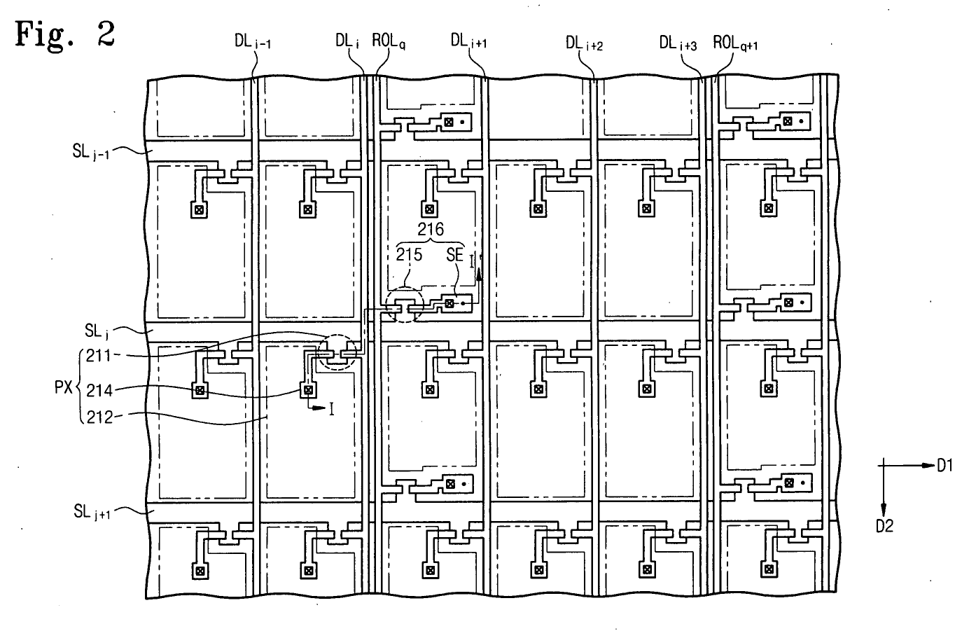

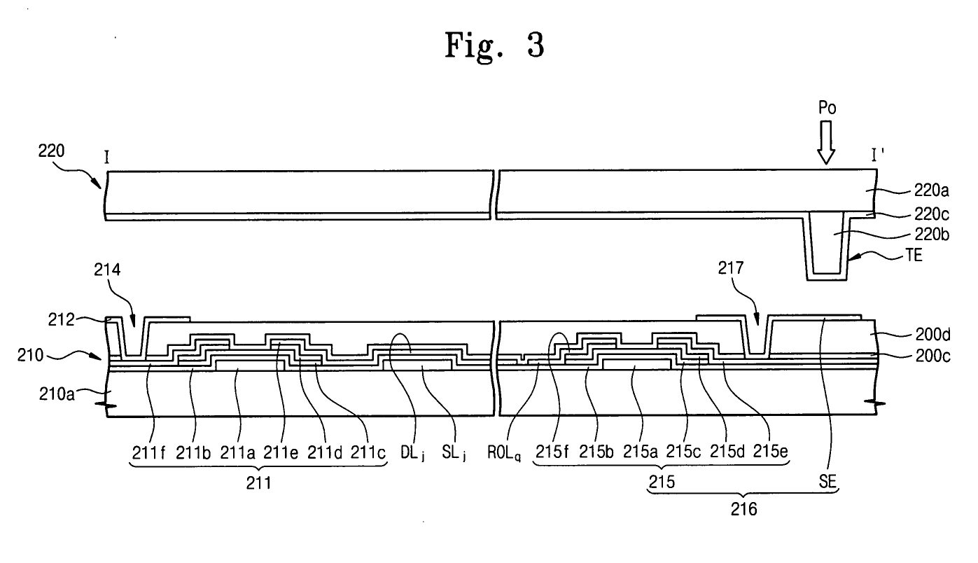

FIG. 1 is an exploded perspective view showing a first exemplary embodiment of a display panel according to the present invention. FIG. 2 is a plan view showing an array substrate of FIG. 1, and FIG. 3 is a sectional view taken along a line I-I′ of FIG. 2.

Referring to FIGS. 1 to 3, a display panel 200 includes an array substrate 210, an opposite substrate 220 facing the array substrate 210, and a liquid crystal layer (not shown) interposed between the array substrate 210 and the opposite substrate 220.

The array substrate 210 includes a first base substrate 210a, a plurality of pixels PX arranged on the first base substrate 210a in a matrix configuration, and a plurality of sensors 216 generating a sensing signal corresponding to an external pressure PO applied thereto.

A plurality of first signal lines ROL1˜ROLk and a plurality of second signal lines SL1˜SLn are formed on the first base substrate 210a in order to perform a touch screen function. Also, a plurality of data lines DL1˜DLm are formed on the first base substrate 210a to receive a data signal, and the data lines DL1˜DLm are insulated from and intersected with the first and second signal lines ROL1˜ROLk and SL1˜SLn.

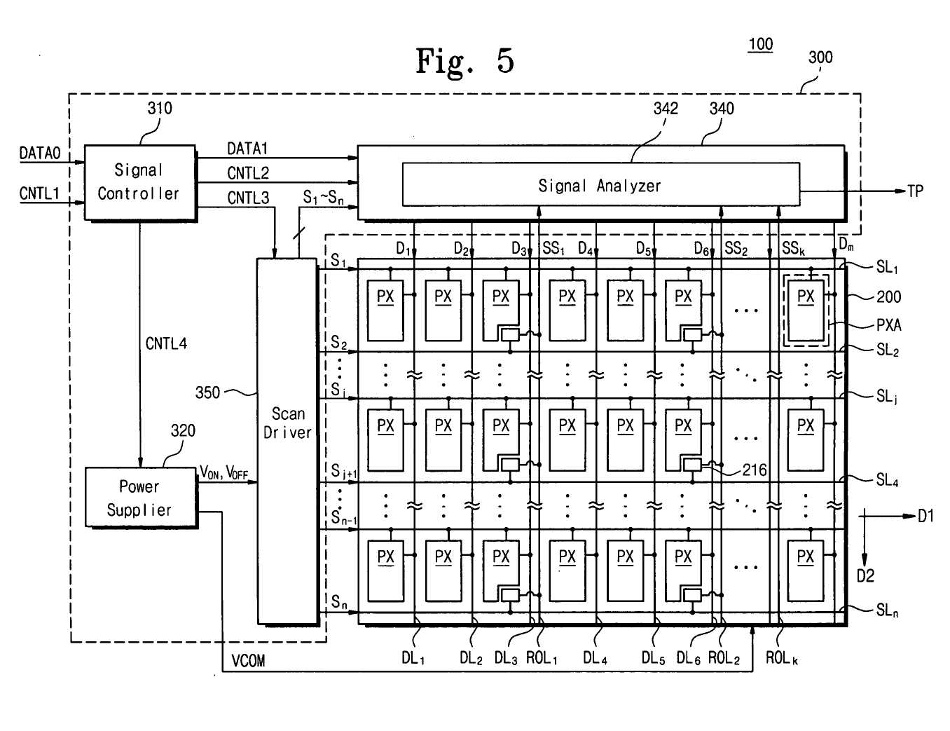

The first signal lines ROL1˜ROLk (hereinafter referred to as “read-out lines”) receive the sensing signal output from the sensors 216 corresponding to the external pressure and outputs the sensing signal to an exterior device (e.g., a signal analyzer 342 shown in FIG. 5). The sensing signal is used as a base when calculating an x-axis coordinate of a touch position. The read-out lines ROL1˜ROLk are insulated from and intersect with the second signal lines SL1˜SLn. That is, the read-out lines ROL1˜ROLk are arranged in a first direction D1, are substantially parallel with each other, and extend in a second direction D2 substantially perpendicular to the first direction D1.

The second signal lines SL1˜SLn (hereinafter, referred to as “gate lines”) sequentially receive a scan signal to substantially simultaneously apply the scan signal to both of the pixels PX and the sensors 216. The scan signal is used as a base when calculating a y-axis coordinate of the touch position. The gate lines SL1˜SLn are arranged in the second direction D2, are substantially parallel with each other, and extend in the first direction D1.

The data lines DL1˜DLm extend in a longitudinal direction (i.e., the second direction D2) which is the same as read-out lines ROL1˜ROLk. At least one data line may be formed between two adjacent read-out lines of the read-out lines ROL1˜ROLk. In the present exemplary embodiment, as shown in FIG. 2, a structure that three data lines DLi+1, DLi+2, and DLi+3 adjacent to each other are formed between two adjacent read-out lines ROLq and ROLq+1 is described below in detail as a representative example.

Also, a plurality of pixel areas are defined on the first base substrate 210a by the gate lines SL1˜SLn and the data lines DL1˜DLm, and the pixels PX are arranged in the pixel areas respectively.

As shown in FIG. 2, each of the pixels PX includes a thin film transistor 211 and a pixel electrode 212. Particularly, the thin film transistor 211 (hereinafter, referred to as “TFT”) and the pixel electrode 212 are formed in a pixel area that is defined by an (i−1)-th data line DLi−1, an i-th data line DLi, a j-th gate line SLj, and a (j+1)-th gate line SLj+1.

The TFT 211 includes a control electrode 211a, an insulating layer 211b, an active layer 211c, an ohmic contact layer 211d, an input electrode 211e, and an output electrode 211f. The control electrode 211a is branched from the gate line SLj. The insulating layer 211b covers the control electrode 211a and the gate line SLj. The active layer 211c and the ohmic contact layer 211d are sequentially formed on the insulting layer 211b to be partially overlapped with the control electrode 211a. The input electrode 211e is branched from the data line DLi and covers the ohmic contact layer 211d. The output electrode 211f is substantially simultaneously formed with the input electrode 211e through the same patterning process. Thus, the output electrode 211f is formed and spaced apart from the input electrode 211e by a predetermined distance to cover the ohmic contact layer 211d.

The TFT 211 electrically connects the pixel electrode 212 and the data line DLj. The output electrode 211f is electrically connected to the pixel electrode 212 through a contact hole 214 formed through intervening layers between the output electrode 211f and the pixel electrode 212.

The TFT 211 is covered by a protective layer 200c and a planarization layer 200d sequentially formed thereabove. The protective layer 200c includes a silicon nitride layer SiNx or a silicon oxide layer SiOx to cover the TFT 211, and the planarization layer 200d is formed on the protective layer 200c and may include an organic insulating layer that planarizes the array substrate 210. The protective layer 200c and the planarization layer 200d are provided with the contact hole 214 through which the output electrode 211f and the pixel electrode 212 are electrically connected to each other. In each pixel area PX, the TFT 211 and the pixel electrode 212 have the same structure as the above-described structure.

The sensors 216 included in the first base substrate 210a may be arranged in all of the pixel areas PX or in a part of pixel areas PX. In the present exemplary embodiment, the sensors 216 are provided at least every three pixel areas that are adjacent to each other in the first direction D1.

Each sensor 216 physically and electrically makes contact with a corresponding touch electrode of touch electrodes TE arranged in the opposite substrate 220 in response to the external pressure PO. In this case, the touch electrode TE receives a common voltage VCOM. Accordingly, the sensors 216 receive the common voltage VCOM. The sensors 216 output the common voltage VCOM received through the touch electrode TE as the sensing signal to the read-out line ROLq. The read-out line ROLq outputs the sensing signal to the signal analyzer 342 (see, FIG. 5).

As shown in FIGS. 2 and 3, each of the sensors 216 includes a switching device 215 and a sensing electrode SE. The switching device 215 includes a control electrode 215a, an insulating layer 215b covering the control electrode 215a, an active layer 215c, an ohmic contact layer 215d, an input electrode 215e, and an output electrode 215f. The control electrode 215a is branched from the gate line SLj that is electrically connected to the TFT 211. The insulating layer 215b covers the control electrode 215a and the gate line SLj. The active layer 215c and the ohmic contact layer 215d are formed on the insulating layer 215b to be partially overlapped with the control electrode 215a.

The input electrode 215e is electrically connected to the sensing electrode SE and receives the common voltage VCOM through the sensing electrode SE. The output electrode 215f is spaced apart from the input electrode 215e by a predetermined distance and branched from the read-out line ROLq. The switching device 215 is covered by the protective layer 200c and the planarization layer 200d that are sequentially formed thereabove. Consequently, a manufacturing process of the switching device 215 is as same as that of the TFT 211. Thus, additional manufacturing process is not necessary for the switching device 215, so that any additional manufacturing cost may be saved.

The sensing electrode SE is formed on the planarization layer 200d and is overlapped with the input electrode 215e of the switching electrode SE, and the sensing electrode SE is electrically connected to the input electrode 215e of the switching device 215 through a contact hole 217 formed through intervening layers between the sensing electrode SE and the input electrode 215e of the switching device 215. The sensing electrode SE and the pixel electrode 212 are substantially simultaneously formed through a same process.

As shown in FIGS. 1 and 3, the opposite substrate 220 includes a second base substrate 220a facing the first base substrate 210a, an insulating part 220b, and a common electrode layer 220c.

The second base substrate 220a may include a transparent insulating material as glass. Also, in order to allow the display panel 200 to have the touch screen function, the second base substrate 220a may include a plastic material as polycarbonate that bends easily by a slight external pressure.

The insulating part 220b includes an insulating material such as silicon oxide and is partially protruded from the second base substrate 220a in a predetermined region. Particularly, the insulating part 220b is protruded from the second base substrate 220a toward the first base substrate 210a by a predetermined height and formed in a region corresponding to the sensing electrode SE that is formed on the first base substrate 210a. The protruded height of the insulating part 220b is shorter than a distance of a cell gap (not shown) between the array substrate 210a and the opposite substrate 220.

The common electrode layer 220c includes a transparent conductive material such as indium tin oxide (ITO) or indium zinc oxide (IZO) and is formed over entire surface of the second base substrate 220a.

Particularly, the common electrode layer 220c covers the insulating part 220b and receives the common voltage VCOM that is used to align liquid crystals included in the liquid crystal layer. The common electrode layer 220c is bent in a direction to the first base substrate 210a together with the second base substrate 220a that is bent according to the external pressure PO, and the common electrode layer 220c physically and electrically makes contact with the sensing electrode SE. Since the sensing electrode SE is electrically connected to the input electrode 215e of the switching device 215 through the contact hole 217, the common electrode layer 220c and the sensors 216 are electrically connected to each other. Accordingly, the sensors 216 may receive the common voltage VCOM.

The sensors 216 apply the common voltage VCOM to a corresponding read-out line ROLq as the sensing signal in response to the scan signal applied through the gate line SLj. The sensing signal applied to the read-out line ROLq is input to the signal analyzer 342 (see, FIG. 5), and the signal analyzer 342 calculates the x-axis coordinate and the y-axis coordinate of the touch position to which the external pressure PO is applied using the sensing signal and the scan signal.

The touch electrode TE and the sensing electrode SE are formed to not overlap with transmission areas of the pixels PX, so that an opening ratio of the pixels PX may not be affected. Although not shown in FIGS. 1 to 3, the display panel 200 may further include a cell gap maintaining member that makes the first base substrate 210a to be spaced apart from the second base substrate 220a, so that an interval between the first and second base substrates 210a and 220a may be uniformly maintained. As an example of the present embodiment, the cell gap maintaining member may be a column spacer.

After the touch electrode TE makes contact with the sensing electrode SE according to the external pressure PO applied from a top of the opposite substrate 220, the second base substrate 220a is maintained to have the uniform interval from the first base substrate 210a due to an elasticity of the column spacer.

The switching device 215 included in each sensor 216 outputs the sensing signal to a corresponding read-out line of the read-out lines ROL1˜ROLk in response to the scan signal that is sequentially applied to the gate lines SL1˜SLn. That is, the sensors 216 perform a sensing operation in response to the scan signal that is sequentially applied to the gate lines SL1˜SLn. Thus, a sensing timing of the sensors 216 depends on a scan timing of the scan signal. As a result, the display panel 200 may calculate a plurality of touch coordinates corresponding to multiple touches that are applied substantially simultaneously.

For instance, when external pressures are applied in several different locations from the top of the opposite substrate 220, each scan signal output through a corresponding read-out line is used to calculate the x-axis coordinate. Since the sensors 216 output the sensing signals to the corresponding read-out line in response to the scan timing of the scan signal, output timings of the sensing signals are different from each other. That is, since the output timings of the sensing signals are determined according to the scan timing of the scan signal, when counting each scan signal corresponding to the sensing timing of the sensing signal, the y-axis coordinate may be calculated based on the counted result of the scan signal.

As a result, the y-axis coordinate is calculated according to the scan timing of the scan signal, therefore multiple touch coordinates corresponding to the multiple touches may be calculated.

When an operation timing of the sensors 216 is defined as a sensing timing, the sensing timing of the sensors 216 depend on the scan timing of the scan signal S1˜Sn because the sensors 216 and the pixels PX are substantially simultaneously operated in response to the scan signal S1˜Sn applied through the same gate line. That is, the sensing operation of the sensors 216 is performed at every frame of the display panel 200.

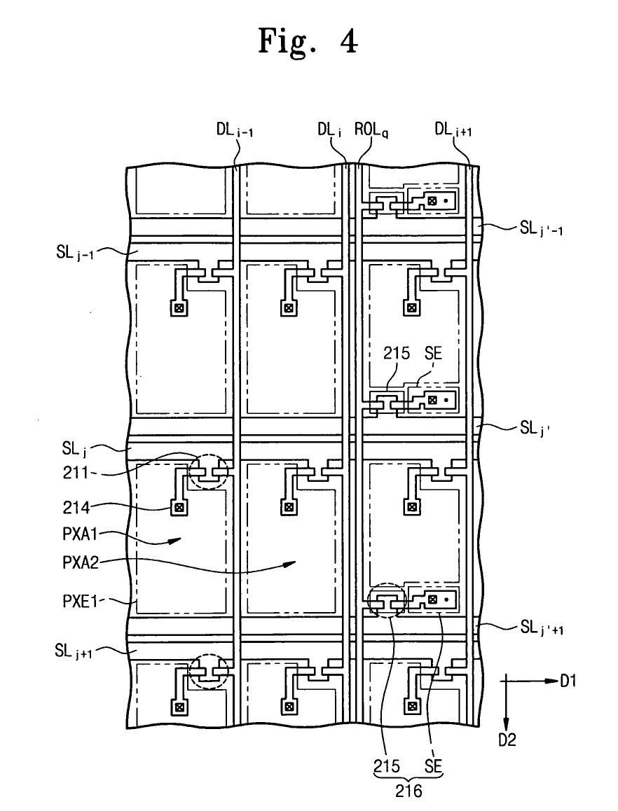

FIG. 4 is a plan view of a second exemplary embodiment of an array substrate according to the present invention. In FIG. 4, the same reference numerals denote the same elements in FIG. 2, and thus detailed descriptions of the same elements are omitted in order to avoid redundancy.

As shown in FIG. 4, in order to improve a sensing capability of the sensors 216, separate gate lines SLj−1′, SLj′, and SLj+1′ are added to the array substrate and separate scan signals are further applied to the added gate lines SLj−1′, SLj′, and SLj+1′, respectively, without relating to the scan signals as the above-described embodiment.

FIG. 5 is a block diagram showing an exemplary embodiment of a display apparatus having the display panel of FIG. 1 according to the present invention. In FIG. 5, the same reference numerals denote the same elements in FIG. 1, and thus detailed descriptions of the same elements are not provided.

Referring to FIG. 5, a display apparatus 100 includes a display panel 200 and a panel driver 300.

The display panel 200 includes n gate lines SL1˜SLn and k read-out lines ROL1˜ROLk. Also, the display panel 200 includes m data lines DL1˜DLm extended in a second direction D2 in substantially parallel with the read-out lines ROL1˜ROLk. In the present exemplary embodiment, the number of read-out lines ROL1˜ROLk may be equal to or smaller than the number of the data lines DL1˜DLm.

The display panel 200 includes a plurality of pixel areas PXA defined by the data lines DL1˜DLm and the gate lines SL1˜SLn.

Pixels PX are arranged in the pixel areas PXA, respectively, and each pixel PX is electrically connected to a corresponding gate line of the gate lines SL1˜SLn and a corresponding gate line of the data lines DL1˜DLm. Accordingly, the pixels PX receive scan signals S1˜Sn sequentially applied through the gate lines SL1˜SLn and data signals D1˜Dm applied through the data lines DL1˜DLm. The pixels PX display an image in response to the data signals D1˜Dm input through the data lines DL1˜DLm.

Also, the display panel 200 includes a plurality of sensors 216 each electrically connected to a corresponding read-out line of the read-out lines ROL1˜ROLk and a corresponding gate line of the gate lines SL1˜SLn. In view of a touch resolution, it is ideal that the sensors 216 are arranged in every pixel area PXA of the display panel 200. However, when considering an opening ratio, the number of sensors 216 is desired to be set smaller than the number of pixel areas PXA.

Thus, the number of sensors 216 has to be designed in consideration of the touch resolution and the opening ratio of the display panel 200. In the present exemplary embodiment, the sensors 216 are arranged at every three pixels PXA. That is, the sensors 216 are arranged in one-third of the pixel areas PXA.

As described above, when the sensing electrode SE physically and electrically makes contact with the touch electrode TE corresponding to the external pressure PO, the sensors 216 receive the common voltage VCOM through the touch electrode TE. The sensors 216 output the common voltage VCOM as sensing signals SS1˜SSk in response to the scan signals S1˜Sn sequentially applied through the gate lines SL1˜SLn.

Consequently, the sensors 216 perform the sensing operation in response to the scan signals S1˜Sn applied to the pixels PX. For the sensing operation, a corresponding scan signal applied to a corresponding sensor of the sensors 216 is counted, and the counted result is used as a base when calculating the y-axis coordinate. Thus, the display apparatus 100 does not require a separate IC circuit for calculation of the y-axis coordinate, thereby removing y-axis wires for connection of the IC circuit and the sensors 216 from the display panel 200.

The panel driver 300 includes a signal controller 310, a power supplier 320, a data driver 340, and a scan driver 350.

The signal controller 310 controls a drive of the display apparatus 100. The signal controller 310 receives a source data signal DATA0 of red (R), green (G), and blue (B) and a first control signal CNTL1 from an external host system such as a graphic controller (not shown). The signal controller 310 outputs a first data signal DATA1 in response to the source data signal DATA0 and outputs second, third and fourth control signals CNTL2, CNTL3, and CNTL4 in response to the first control signal CNTL1.

The first data signal DATA1 and the second control signal CNTL2 are applied to the data driver 340, and the third and fourth control signals CNTL3 and CNTL4 are applied to the scan driver 350 and the power supplier 320, respectively.

The first control signal CNTL1 includes a main clock signal, a horizontal synchronization signal, and a vertical synchronization signal and controls a timing of the source data signal DATA0. The second control signal CNTL2 includes a horizontal start signal, an inversion signal, and a data load signal to control the data driver 340. The third control signal CNTL3 includes a start signal, a clock signal, and an output enable signal to control the scan driver 350. The fourth control signal CNTL4 includes a clock signal that controls the power supplier 320.

The power supplier 320 outputs the common voltage VCOM applied to the display panel 200 and gate driving voltages Von and Voff applied to the scan driver 350 in response to the fourth control signal CNTL4.

The data driver 340 changes the first data signal DATA1 to the data signals D1˜Dm in response to the second control signal CNTL2 and controls an output timing of the data signals D1˜Dm to output the data signals D1˜Dm to the data lines DL1˜DLm. Also, the data driver 340 includes the signal analyzer 342.

The scan driver 350 sequentially outputs the scan signals S1˜Sn to the gate lines SL1˜SLn and the signal analyzer 342 of the data driver 340 in response to the third control signal CNTL3.

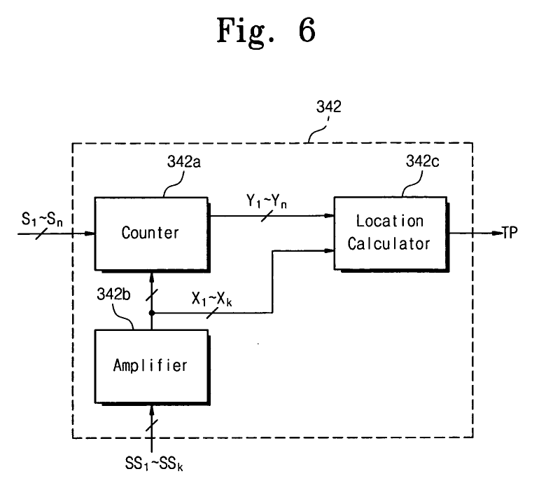

FIG. 6 is a block diagram showing a signal analyzer for the embodiment of FIG. 5.

The signal analyzer 342 includes a counter 342a, an amplifier 342b, and a location calculator 342c.

The counter 342a receives the scan signals S1˜Sn from the scan driver 350 and receives x-axis signals X1˜Xk from the amplifier 342b. The counter 342a counts a scan signal of the scan signals S1˜Sn corresponding to an input timing of the x-axis signals X1˜Xk and outputs the counted result as y-axis signals Y1˜Yk. Then, the y-axis coordinate is calculated using the y-axis signals Y1˜Yk output from the counter 342a.

The amplifier 342b is electrically connected to the read-out lines ROL1˜ROLk and amplifies the sensing signals SS1˜SSk applied through the read-out lines ROL1˜ROLk. The amplified sensing signals are output to the counter 342a and the location calculator 342c as the x-axis signals X1˜Xk.

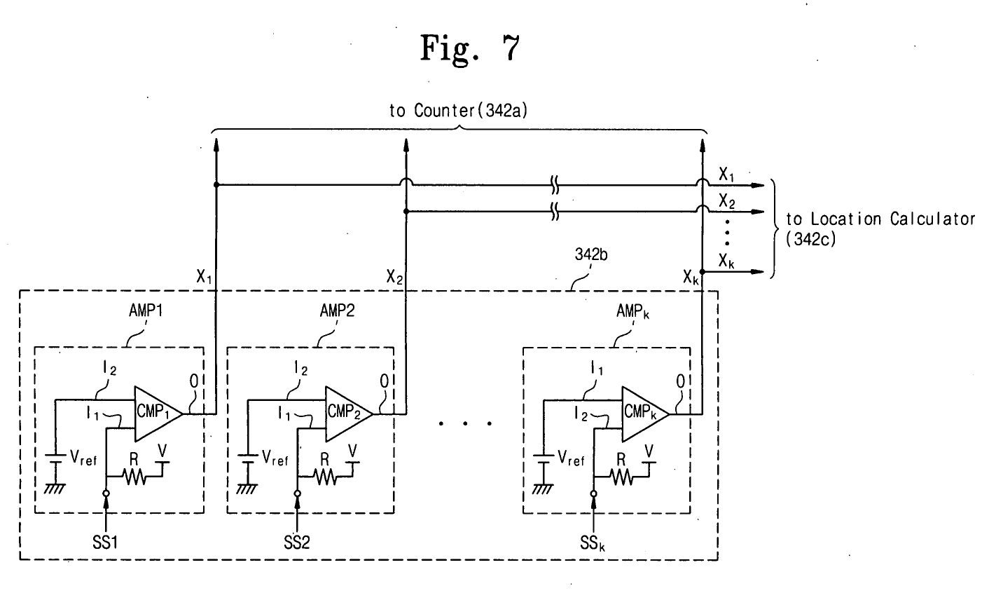

FIG. 7 is a circuit diagram showing the amplifier 342b of FIG. 6.

Referring to FIG. 7, the amplifier 342b includes first to k-th amplifiers AMP1˜AMPk. Each amplifier AMP1˜AMPk has a same circuit configuration and function with each other. Thus, only the first amplifier AMP1 will be described in detail in FIG. 7, and thus the detailed description of the second to k-th amplifiers will be omitted.

The first amplifier AMP1 includes a comparator CMP1 and a resistance R. The comparator CMP1 includes a first input terminal I1 electrically connected to the read-out line ROL2 to receive a sensing signal SS1, a second input terminal I2 receiving a reference signal Vref, and an output terminal O. The comparator CMP1 compares the sensing signal SS1 with the reference signal Vref and amplifies the compared result to output the amplified result through the output terminal O. In the present exemplary embodiment, a detecting sensitivity of the sensing signal SS1 may be improved according to adjustment of a value of the reference signal Vref.

The resistance R is electrically connected between the first input terminal I1 and a first voltage V. The size of the resistance R is set in consideration of a size of the switching device 215 of the sensors 216, a wiring resistance of the read-out lines, and an RC delay according to a parasitic capacitance. More specifically, the size of the resistance R is set to have a resistance value between an on-resistance and an off-resistance of the switching device 215 of the sensors 216.

Referring to FIG. 6 again, the location calculator 342c calculates a last touch coordinate TP in combination of the x-axis signals X1˜Xk from the amplifier 324b and the y-axis signals Y1˜Yk from the counter 342a.

Meanwhile, blocks as the above-mentioned elements arranged in the panel driver 300 of FIG. 5 means not a physical separation but a functional separation. Accordingly, the signal analyzer 342 may be designed separately from the data driver 340.

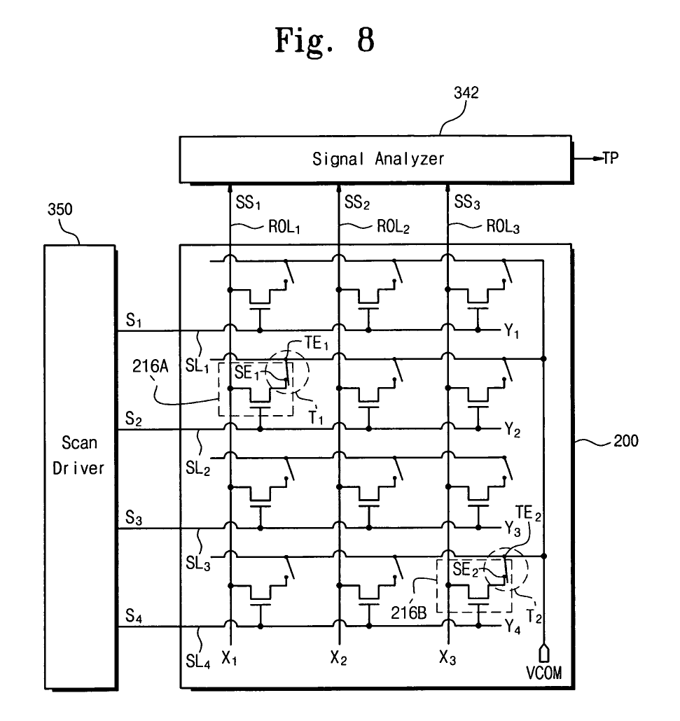

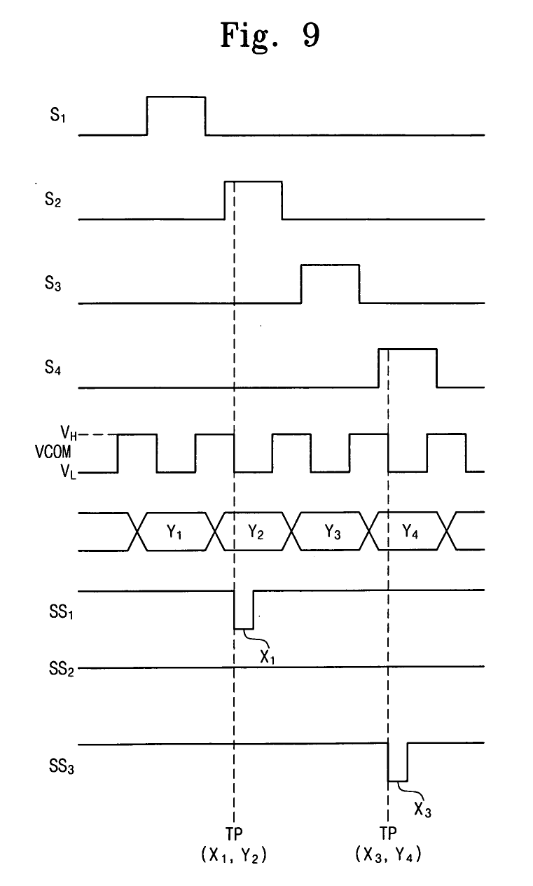

A method of calculating the touch coordinate of the display apparatus is described in detail below with reference to FIGS. 8 and 9.

FIG. 8 is a circuit diagram showing the display panel of FIG. 5, and FIG. 9 is a waveforms diagram showing input and output signals of FIG. 8. For the convenience of explanation, in FIG. 8, only twelve sensors, first to third read-out lines ROL1˜ROL3, and first to fourth gate lines SL1˜SL4 of the display panel 200 are illustrated.

Referring to FIGS. 8 and 9, a first touch electrode TE1 electrically makes contact with a first sensing electrode SE1 corresponding to a first touch T1. The first sensor 216A outputs the common voltage VCOM applied to the first sensing electrode SE1 as the sensing signal SS1. The first sensor 216A outputs the sensing signal SS1 to the signal analyzer 342 through the first read-out line ROL1 in response to the second scan signal S2 applied to the second gate line SL2.

The sensing signal SS1 is amplified as the x-axis signal X1 by the amplifier 342b arranged in the signal analyzer 342. The x-axis signal X1 is input to the location calculator 342c and is analyzed as the x-axis coordinate. The counter 342a arranged in the signal analyzer 342 counts the second scan signal S2 corresponding to an input timing of the sensing signal SS1 to output the counted result as the y-axis signal Y2. The y-axis signal Y2 is input to the location calculator 342c and is analyzed as the y-axis coordinate. The location calculator 342c calculates the last touch coordinate TP based on a combination the analyzed x-axis and y-axis coordinates. Thus, the x-axis coordinate X1 and the y-axis coordinate Y2 are detected as the last touch coordinate TP caused by the first touch T1.

Display apparatus 100 may calculate the multiple touch coordinates corresponding to multiple touches. Following is a calculation method of multiple coordinates corresponding to multiple touches in case that the first touch T1 and a second touch T2 are substantially simultaneously applied. A calculation method of a touch coordinate corresponding to the first touch T1 is as same as the above-mentioned method.

A second touch electrode TE2 electrically makes contact with a second sensing electrode SE2 by the second touch T2. Accordingly, the second sensor 216B outputs the common voltage VCOM applied to the second sensing electrode SE2 as the sensing signal SS3. The second sensor 216B outputs the sensing signal SS3 to the signal analyzer 342 through the third read out line ROL3 in response to the fourth scan signal S4 applied to the fourth gate line SL4.

The signal analyzer 342 analyzes the sensing signal SS3 as the x-axis coordinate X3 and counts the fourth scan signal S4 corresponding to an input timing of the sensing signal SS3 to analyze the counted result as the y-axis coordinate Y4. Thus, the x-axis coordinate X3 and the y-axis coordinate Y4 are detected as the last touch coordinate TP caused by the signal analyzer 342.

As shown in FIG. 9, when the display apparatus 100 is operated in a line inversion driving method, the common voltage VCOM swings between a low voltage V_{L} and a high voltage V_{H}. Thus, a turn-on timing of the switching devices T1 and T2 is required to be synchronized either the low voltage V_{L} or the high voltage V_{H}. In the present exemplary embodiment, when the scan signals S2 and S4 are synchronized with the low voltage V_{L} of the common voltage VCOM, the low voltage V_{L} is output as the sensing signals SS1 and SS3. Although not shown in FIG. 9, when the scan signals S2 and S4 are synchronized with the high voltage V_{H} of the common voltage VCOM, the high voltage V_{H} is output as the sensing signals SS1 and SS3.

When the display apparatus 100 is operated in a dot-inversion driving method, the common voltage VCOM is a direct current voltage. Therefore, the sensors output the common voltage VCOM as the sensing signal.

According to the above, the y-axis coordinate is calculated using the scan signal applied to the pixel. Thus, the display panel does not require the separate signal line that is used to calculate the y-axis coordinate, so that the number of signal lines may decrease.

Also, since the y-axis coordinate is calculated according to the scan signals, the multiple touch coordinates corresponding to the multiple touches may be more precisely calculated.

Although the exemplary embodiments of the present invention have been described, it is understood that the present invention is not limited to these exemplary embodiments but various changes and modifications can be made by one ordinary skilled in the art within the spirit and scope of the present invention as hereinafter claimed.

What is claimed is:

1. A display panel comprising:
an array substrate on which pixels are arranged, the array substrate comprising:
a plurality of first signal lines;
a plurality of second signal lines intersecting with the first signal lines; and
sensors receiving a scan signal through the second signal lines and generating a sensing signal in response to application of an external pressure to output the sensing signal through the first signal lines in response to the scan signal.

2. The display panel of claim 1, further comprising an opposite substrate facing the array substrate, wherein the opposite substrate comprises:
a base substrate;
an insulating part on the base substrate, the insulating part having a protruding portion extending from the base substrate; and
a touch electrode covering at least a portion of the base substrate and the protruding portion of the insulating part and receiving a voltage.

3. The display panel of claim 2, wherein the sensors make contact with the touch electrode responsive to application of an external pressure to generate the voltage as the sensing signal.

4. The display panel of claim 3, wherein each sensor comprises:
a sensing electrode positioned to selectively make contact the touch electrode responsive to the application of external pressure; and
a switching device electrically coupled to the sensing electrode.

5. The display panel of claim 4, wherein the switching device comprises:
an input electrode electrically connected to the sensing electrode to receive a voltage through the sensing electrode;
an output electrode branched from the first signal lines to output the common voltage; and
a control electrode branched from the second signal lines to receive the scan signal.

6. The display panel of claim 1, wherein the array substrate further comprises:
a plurality of data lines extending in a direction substantially parallel to the first signal lines to receive a data signal; and
thin film transistors electrically connected to the data lines to provide the data signal to pixels in response to the scan signal, and wherein the second signal lines serve as gate lines providing the scan signal to the thin film transistors.

7. The display panel of claim 1, wherein the array substrate further comprises:
a first base substrate;
gate lines on the first base substrate, the gate lines extending substantially parallel with the second signal lines;
data lines intersecting with the gate lines; and
a plurality of thin film transistors each of which is connected to an associated gate and data line.

8. The display panel of claim 7, further comprising:
a second base substrate facing the first base substrate;
an insulating part having a portion partially protruding from the second base substrate; and
a touch electrode covering the second base substrate and the protruded insulating part and receiving a voltage, and
wherein the touch electrode makes contact with a corresponding sensor of the sensors by the external pressure to output the voltage as the sensing signal.

9. A display apparatus comprising:
a scan driver sequentially outputting a scan signal;
a data driver outputting a data signal; and
a display panel comprising pixels that display an image in response to the scan signal and the data signal, and
the display panel comprising:
a plurality of first signal lines;
a plurality of second signal lines intersecting with the first signal lines; and
sensors receiving a scan signal through the second signal lines and generating a sensing signal in response to application of an external pressure to output the sensing signal through the first signal lines in response to the scan signal.

10. The display apparatus of claim 9, wherein the display panel comprises:
an array substrate on which pixels are arranged; and
an opposite substrate facing the array substrate and comprising a touch electrode that receives a common voltage.

11. The display apparatus of claim 10, wherein the array substrate further comprises:
a plurality of data lines extending in a direction substantially parallel to the first signal lines to receive a data signal; and
thin film transistors electrically connected to the data lines to provide the data signal to pixels in response to the scan signal, and wherein the second signal lines serve as gate lines providing the scan signal to the thin film transistors.

12. The display apparatus of claim 10, wherein the array substrate further comprises:
gate lines extended in substantially parallel with the second signal lines;
data lines intersecting with the gate lines; and
thin film transistors each connected to the gate lines and the data lines.

13. The display apparatus of claim 10, wherein the sensors make contact with the touch electrode by the external pressure to generate the common voltage as the sensing signal.

14. The display apparatus of claim 13, wherein each sensor comprises:
a sensing electrode that makes contact with the touch electrode by the external pressure; and
a switching device electrically connected to the sensing electrode.

15. The display apparatus of claim 14, wherein the switching device comprises:
an input electrode electrically connected to the sensing electrode to receive the common voltage through the sensing electrode;
an output electrode electrically connected to the first signal lines to output the common voltage as the sensing signal; and
a control electrode electrically connected to the second signal lines to receive the scan signal.

16. The display apparatus of claim 15, wherein the common voltage is an alternating current voltage that swings between a high voltage and a low voltage.

17. The display apparatus of claim 16, wherein the switching device outputs either the high voltage or the low voltage as the sensing signal in response to the scan signal.

18. The display apparatus of claim 15, wherein the common voltage is a direct current voltage.

19. The display apparatus of claim 18, wherein the switching device outputs the direct current voltage as the sensing signal in response to the scan signal.

20. The display apparatus of claim 9, wherein the data driver comprises a signal analyzer that calculates a coordinate value of a position to which the external pressure is applied in response to the sensing signal and the scan signal.

21. The display apparatus of claim 20, wherein the signal analyzer comprises:
an amplifier receiving the sensing signal from the display panel to amplify the sensing signal;
a counter receiving the amplified sensing signal from the amplifier and the scan signal from the scan driver and counting the scan signal corresponding to an input timing of the amplified sensing signal to output the counted result; and
a location calculator calculating the amplified sensing signal and the counted result as an x-axis coordinate and an y-axis coordinate, respectively, and combining the calculated x-axis and y-axis coordinates to calculate a last touch coordinate.
